(19) United States
(12) Patent Application Publication
(10) Pub. No.: US 2014/0182959 A1
(43) Pub. Date: Jul. 3, 2014

(54) ACOUSTIC NOISE DAMPING FOR A VEHICLE

(71) Applicant: GM GLOBAL TECHNOLOGY OPERATIONS LLC, Detroit, MI (US)

(72) Inventors: MARK A. STEBBINS, BLOOMFIELD HILLS, MI (US); SHAWN G. QUINN, GRAND BLANC, MI (US); CHRISTOPHER A. STIRLEN, MILFORD, MI (US)

(73) Assignee: GM GLOBAL TECHNOLOGY OPERATIONS LLC, Detroit, MI (US)

(21) Appl. No.: 13/731,840

(22) Filed: Dec. 31, 2012

(51) Int. Cl. B62D 25/06; F16F 9/50; F16F 9/53

(52) U.S. Cl. CPC B62D 25/06; F16F 9/535; F16F 9/50
USPC 180/89.1; 701/36; 188/267.2; 188/266.1

(57) ABSTRACT

Methods and apparatus are provided for attenuating vibrations in the header of a vehicle to reduce acoustic noise. The apparatus includes a fluid damper configured to be coupled to a header of a vehicle and an accelerometer for sensing vibrations in the header and providing a signal to adjust the fluid damper thereby attenuating the vibrations. A method is provided which includes receiving a signal indicating a vibration in a header of a vehicle and adjusting a fluid damper coupled to the header in response to the signal thereby attenuating the vibration.

### TECHNICAL FIELD

The technical field generally relates to acoustic damping, and more particularly, to a system and method for controlling/regulating an electronically controlled vibration damping system that attenuates acoustic noise in a vehicle.

### BACKGROUND

Passenger vehicles may utilize a variety of different structures or techniques to attenuate, minimize, or otherwise reduce the amount of noise or acoustic vibrations that certain vehicle components emit. For example, engines, transmissions, exhaust systems, tires, or other components may be designed to be relatively quiet when in use so that passenger compartment noise is reduced. Another technique is to provide components that attenuate vibrations that would otherwise reach the passenger cabin by absorbing and/or dissipating vibrational energy, for example. Various attributes can affect the acoustic properties of such vibration-attenuating components, including their overall mass, composition, density, stiffness, thickness and location, to name a few.

One source or amplifier of acoustic noise that may be objectionable to passengers is the roof or roof section of a vehicle. The roof may vibrate due to movement of the vehicle, the interaction of the vehicle's suspension system with the road surface or other factors. Low frequency movement toward and away from the passenger compartment is akin to the vibrations of a drum head producing acoustic noise (referred to as “boom”) within the passenger compartment.

Conventionally, passive vibration absorbers have been attached to headers that stiffen and support the roof in an attempt to attenuate (absorb) the unwanted vibrations, and thus, attenuate the acoustic noise. However, passive absorbers are sometimes ineffective since passive absorbers are tuned to a predetermined mass for selected driving conditions.

Accordingly, it is desirable to provide a vibration attenuation system for vehicles that is effective at attenuating vibrations in vehicle headers to reduce acoustic noise. In addition, it is desirable to have such a system be closed loop so as to be dynamically responsive to vibrations. Furthermore, other desirable features and characteristics of the present invention will become apparent from the subsequent detailed description and the appended claims, taken in conjunction with the accompanying drawings and the foregoing technical field and background.

### SUMMARY

An apparatus is provided for attenuating vibrations in the header of a vehicle to reduce acoustic noise. In one embodiment, the apparatus includes a fluid damper configured to be coupled to a header of a vehicle and an accelerometer for sensing vibrations in the header and providing a signal to adjust the fluid damper thereby attenuating the vibrations.

A method is provided for attenuating vibrations in the header of a vehicle to reduce acoustic noise. In one embodiment, the method includes receiving a signal indicating a vibration in a header of a vehicle and adjusting a fluid damper coupled to the header in response to the signal thereby attenuating the vibration.

### DESCRIPTION OF THE DRAWINGS

The exemplary embodiments will hereinafter be described in conjunction with the following drawing figures, wherein like numerals denote like elements, and wherein:

FIG. 1 is top plan view of a vehicle in accordance with an embodiment;

FIG. 2 is cross-sectional view of the fluid damper of FIG. 1 in accordance with a first embodiment;

FIG. 3 is cross-sectional view of the fluid damper of FIG. 1 in accordance with another embodiment; and

FIG. 4 is flow diagram illustrating a method in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

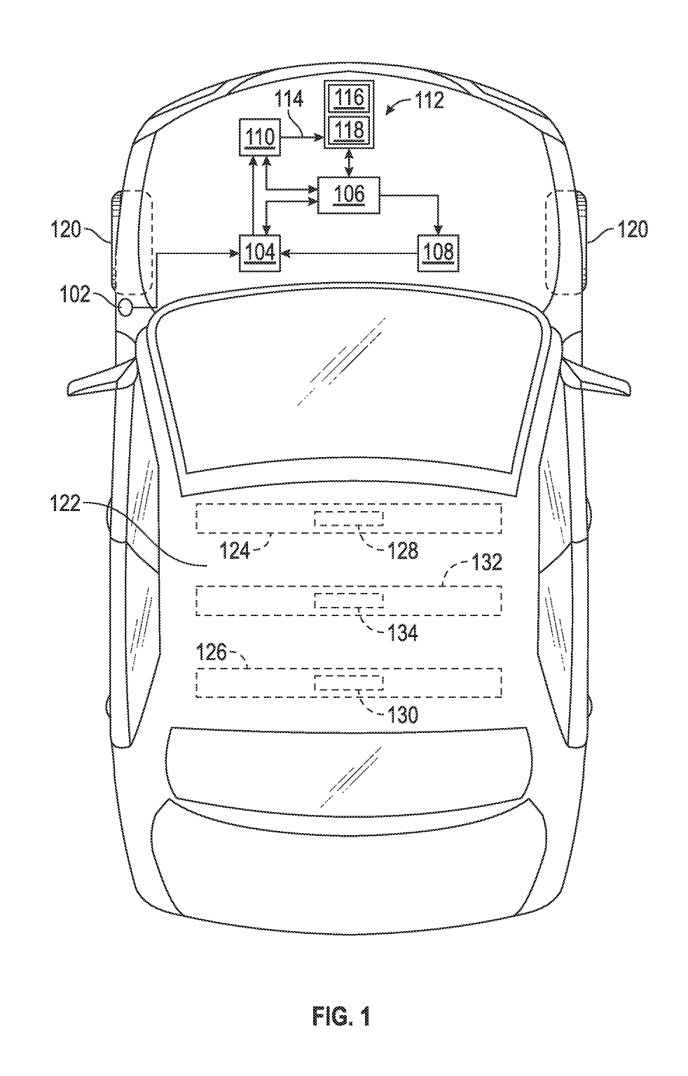

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-3 are merely illustrative and may not be drawn to scale.

FIG. 1 is a simplified schematic representation of an embodiment of a vehicle 100 according to exemplary embodiments. Although the vehicle 100 is illustrated as a purely electric vehicle, the techniques and concepts described herein are also applicable to hybrid electric vehicles or vehicles employing internal combustion engines. The vehicle 100 may be, for example, a sedan, a wagon, a mini-van, a truck, or a sport utility vehicle (SUV), and may be two-wheel drive (2WD), four-wheel drive (4WD), or all-wheel drive (AWD). In internal combustion or hybrid electric vehicle embodiments, the vehicle 100 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine in addition to an electric motor.

The illustrated embodiment of the vehicle 100 includes, without limitation: a plug-in charging port 102 coupled to an energy storage system 104; a control module 106 coupled to a generator 108 for charging the energy storage system 104; and an inverter 110 coupled to the energy storage system 104 for providing AC power to a powertrain 112 via a cable 114. The powertrain 112 includes an electric motor 116 and a transmission 118 for driving wheels 120 to propel the vehicle 100.

The plug-in charging port 102 may be configured as any suitable charging interface, and in one embodiment, comprises a charging receptacle compatible with the J1772 standard, which receives a charging cable with compatible plug (not shown). The energy storage system 104 may be realized as a rechargeable battery pack having a single battery module or any number of individual battery cells operatively interconnected (e.g., in series or in parallel), to supply electrical energy. A variety of battery chemistries may be employed within the energy storage system 104 such as, lead-acid, lithium-ion, nickel-cadmium, nickel-metal hydride, etc.

The control module 106 may include any type of processing element or vehicle controller, and may be equipped with nonvolatile memory, random access memory (RAM), discrete and analog input/output (I/O), a central processing unit, and/or communications interfaces for networking within a vehicular communications network. The control module 106 is coupled to the energy storage system 104, the generator 108, the inverter 110 and the powertrain 112 and controls the flow of electrical energy between the these modules depending on a required power command, the state of charge of the energy storage system 104, etc.

As noted above, in hybrid-electric embodiments, the powertrain 112 includes an electric motor 116 and a transmission 118 configured within a powertrain housing. The electric motor 16 includes a rotor and stator (not shown) operatively connected via the transmission 118 to at least one of the wheels 120 to transfer torque thereto for propelling the vehicle 100. It will be appreciated that in hybrid-electric embodiments, the powertrain 112 may be implemented as a series hybrid-electric powertrain or as a parallel hybrid-electric powertrain.

As illustrated in FIG. 1, the vehicle 100 includes a roof 122 supported by a front header 124 and a rear header 126 (each shown in dashed lines as being below the roof 122). Also shown in FIG. 1, the vehicle 100 includes a roof supported by a row bow 132 (shown in dashed lines as being below the roof). However, it will be appreciated that any number of headers and roof bows may be employed depending upon the body-type of the vehicle (e.g., sedan, wagon, mini-van, truck, or sport utility vehicle). The headers 124 and 126 and roof bow 132 provide support or stiffening, which among other things, reduce vibrations in the roof 122. Vibrations in the roof 122 are generally undesirable as the vibrations may produce acoustic noise (referred as “boom”) within the passenger compartment of the vehicle 100. That is, the roof 122 may be viewed as the head of a drum moving toward and away room the passenger compartment creating low frequency noise that may be objectionable to passengers of the vehicle. According to various embodiments, the headers 124, 126 and roof bow 132 of the vehicle 100 are equipped with a respective fluid damper 128, 130 and 134. As will be discussed in more detail below, the fluid dampers 128, 130 and 134 are dynamically adjustable fluid dampers providing an electrically controlled mass that attenuates (absorbs) vibrations in the headers 124, 126 and the roof bow 132 transmitted to them by the roof 122. Sensors may be integrated with the fluid dampers 128, 130 and 134 or coupled to the headers 124, 126 and the roof bow 132 to provide a signal indicating that vibrations are present. In this way, a closed-loop control system is provided to achieve active and dynamic vibration damping.

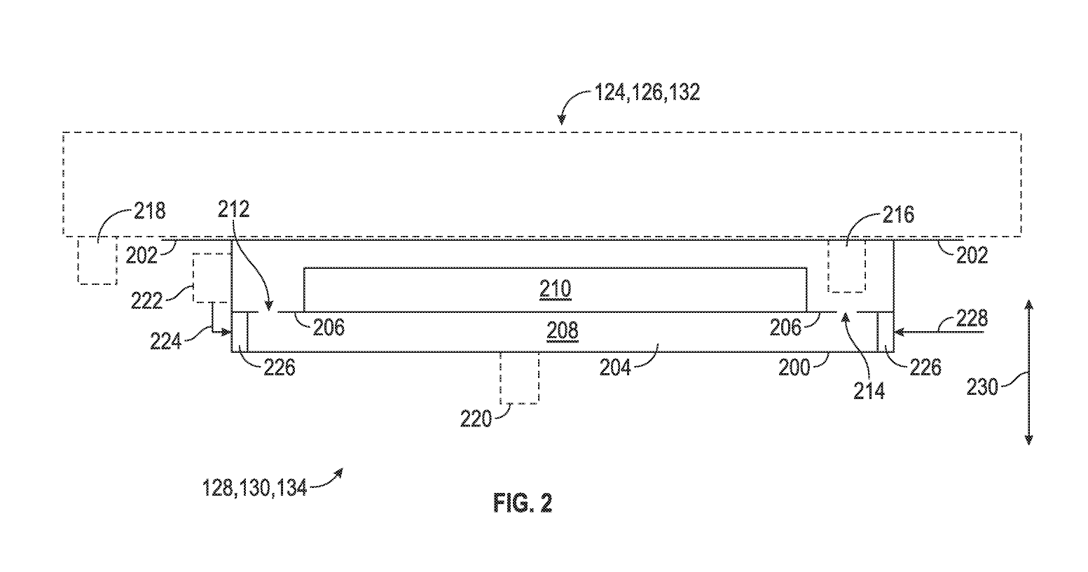

FIG. 2 is a cross-sectional view of an exemplary embodiment of an adjustable fluid damper 128, 130, 134. The illustrated embodiment comprises a Magneto-Rheological damper contained in a housing 200 that is coupled to the header 124, 126, 132 via mounting brackets 202. A reservoir 204 is defined within the housing 200 by a diaphragm 206. The reservoir 204 contains a Magneto-Rheological fluid 208 that has the property of changing its viscosity responsive to an electromagnetic field applied across the reservoir or an electric current passing through the Magneto-Rheological fluid 208. In a non-limiting embodiment, an example of the Magneto-Rheological fluid 208 consists of but is not limited to an approximately twenty percent iron fluid (FE 20% by volume fraction) that will undergo a viscosity change responsive to an electric field or current.

Above the diaphragm 206, a base mass 210 is mounted to the upper portion of the housing 200 by mounts 212. In non-limiting exemplary embodiments, the base mass 210 has a mass of approximately 0.4 kilograms for the fluid damper 128 coupled to the front header 124. In some non-limiting embodiments, the base mass 210 has a mass of approximately 0.25 kilograms for the fluid damper 130 coupled to the rear header 126 and the roof bow 132. In some embodiments, the diaphragm 206 has one or more orifices 212, 214 formed therein allowing acoustic energy to be directly absorbed by varied viscosity of the Magneto-Rheological fluid 208. Together the base mass 210 and the Magneto-Rheological fluid 208 provide an electrically adjustable (or tunable) mass effective at attenuating (absorbing) vibrations in the headers 124, 126, and the roof bow 132. The configuration is particularly effective at attenuating (absorbing) vertical vibrations (indicated by the double arrow 230) transmitted by the roof 122, for example in a frequency range of 50-90 Hertz. This affords an advantage over passive absorbers in that the overall size (or “package”) of the fluid dampers 128, 130 and 134 is reduced.

According to various embodiments, a closed-loop control system is provided for the fluid dampers 128, 130 and 134 by incorporating sensors or accelerometers to provide a signal for adjusting the fluid dampers 128, 130 and 132. In some embodiments, the sensor 216 is integrated within the housing 200. In some embodiments, the sensor 218 is coupled to the headers 124, 126 and the roof bow 132. In some embodiments, the sensor 220 can be placed on the housing 200 at an external bottom portion. In some embodiments, the sensor 222 can be placed on the housing 200 at an external side portion. Regardless of the placement of the sensor, a signal 224 is provided to the fluid dampers 128, 130 and 134 causing the Magneto-Rheological fluid 208 to change its viscosity. In some embodiments connections 226 comprise electromagnets within the reservoir 204 that apply an electromagnetic field across the Magneto-Rheological fluid 208 to change its viscosity. In some embodiments, connections 226 comprise electrodes for passing a current through the Magneto-Rheological fluid 208 to change its viscosity. Additionally or alternately, the fluid dampers 128, 130 and 134 could be controlled (or also controlled) by the control module (106 of FIG. 1) via connection 228. In this way, factors such as the speed of the vehicle 100 or the revolutions (e.g., revolution per minute (RPM)) of the engine (116 of FIG. 1) or transmission (118 of FIG. 1) can be taken into account for adjusting the fluid dampers 128, 130 and 134.

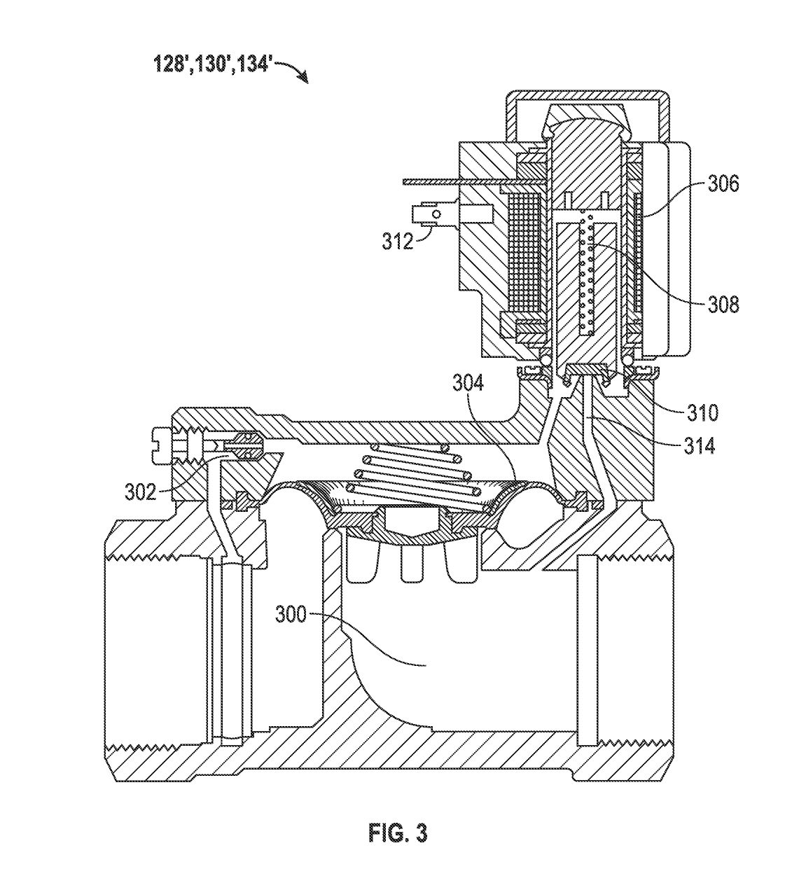

FIG. 3 is a cross-sectional view of another exemplary embodiment of an adjustable fluid damper 128′, 130′ and 134′. As will be appreciated, the adjustable fluid damper 128′, 130′ and 134′ can be operably fastened to the header via a mounting bracket (not shown in FIG. 3) and using adhesives, mechanical fasteners, riveting, welding, etc. The illustrated embodiment comprises a servo-controlled fluid damper comprising a main orifice 300 and an equalizing orifice 302 separated by a diaphragm 304. A coil 306, armature spring 308 and valve plate 310 control how much hydrolytic fluid passes from a port 312 into the main orifice 300 via a pilot orifice 314. By controlling the volume of hydraulic fluid in the main orifice 300, the mass of the servo-controlled fluid damper is adjusted thereby attenuating vibrations in the header (124 and 126 in FIG. 1) and/or roof bow (132 in FIG. 1) of the vehicle (100 of FIG. 1).

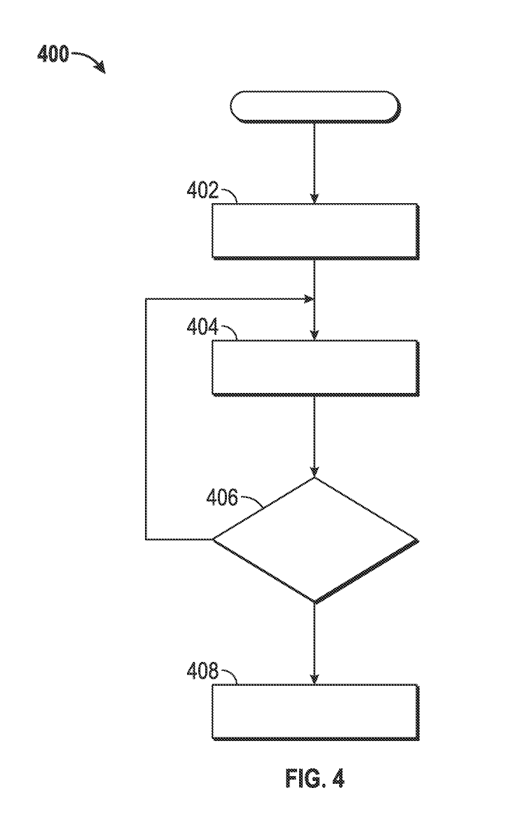

FIG. 4 illustrates a flow diagram useful for understanding the method 400 for attenuating vibrations in the header (124, 126 of FIG. 1) of the vehicle (100 of FIG. 1). The various tasks performed in connection with the method 400 of FIG. 4 may be performed by software, hardware, firmware, or any combination thereof For illustrative purposes, the following description of the method 400 of FIG. 4 may refer to elements mentioned above in connection with FIGS. 1-3. In practice, portions of the method of FIG. 4 may be performed by different elements of the described system. It should also be appreciated that the method of FIG. 4 may include any number of additional or alternative tasks and that the method of FIG. 4 may be incorporated into a more comprehensive procedure or process having additional functionality not described in detail herein. Moreover, one or more of the tasks shown in FIG. 4 could be omitted from an embodiment of the method 400 of FIG. 4 as long as the intended overall functionality remains intact.

The routine (method 400) begins in step 402 where a signal (224 or 228 of FIG. 2) is received indicating that a vibration exists in the header (124, 126 of FIG. 1) of the vehicle (100 of FIG. 1). The signal can be provided by sensors or accelerometers position in various positions, some of which were described above in connection with FIG. 2. Additionally or alternately, the signal could be provided by the control module (106 of FIG. 1). In step 404, the fluid damper (128, 130 of FIG. 2) is adjusted in response to this signal effectively adjusting its mass (the collective mass provided by the base mass 210 and the viscosity of the Magneto-Rheological fluid 208) to attenuate (absorb) some or all of the vibration. This may be achieved by varying an electromagnetic field across the Magneto-Rheological fluid 208 or modifying a current passing through the Magneto-Rheological fluid 208. In step 406, it may be determined whether the vibration(s) have been effectively attenuated. In some embodiments, this is determined by the continued reception or absence of the signal. In some embodiments, the signal (if still present) is compared to a threshold to determine if the vibration(s) have been attenuated below a level perceivable by the operator of the vehicle 100. If so, the routine ends (step 408) until the signal is received yet again in step 402. If not, the routine returns to step 404 for continued adjustment of the fluid damper 130. In this way, a closed-loop control system is provided for dynamic and continuous attenuation of vibrations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method, comprising:
receiving a signal indicating a vibration in a header supporting a roof of a vehicle; and
adjusting a fluid damper coupled to the header in response to the signal, thereby attenuating the vibration to reduce acoustic noise within the vehicle.

2. The method of claim 1, further comprising sensing the vibration via an accelerometer, the accelerometer providing the signal.

3. The method of claim 1, further comprising providing the signal from a control module to adjust the fluid damper.

4. The method of claim 3, further comprising determining a speed of the vehicle and providing the signal from the control module based upon the speed of the vehicle.

5. The method of claim 3, further comprising determining engine revolutions of an engine of the vehicle and providing the signal from the control module based upon the engine revolutions.

6. The method of claim 1, wherein adjusting the fluid damper comprises varying an electromagnetic field applied to a Magneto-Rheological fluid within the fluid damper.

7. The method of claim 1, wherein adjusting the fluid damper comprises varying hydraulic fluid within the fluid damper via a servo actuated value.

8. The method of claim 1, wherein adjusting the fluid damper attenuates vibrations in the header of the vehicle in a 50-90 Hertz range.

9. A system, comprising:
a fluid damper configured to be coupled to a header supporting a roof of a vehicle; and
an accelerometer for sensing vibrations in the header and providing a signal to adjust the fluid damper thereby attenuating the vibrations to reduce acoustic noise within the vehicle.

10. The system of claim 9, wherein the fluid damper comprises a Magneto-Rheological fluid damper.

11. The system of claim 10, wherein the Magneto-Rheological fluid damper further comprises:
a mass configured to be a base tuning element;
a Magneto-Rheological fluid;
a diaphragm between the mass the Magneto-Rheological fluid; and
an electromagnetic field source providing a varying electromagnetic field to the Magneto-Rheological fluid responsive to the signal.

12. The system of claim 11, wherein the mass is approximately:
0.25 kilograms when the Magneto-Rheological fluid damper is coupled to a rear header of the vehicle;
0.4 kilograms when the Magneto-Rheological fluid damper is coupled to a front header of the vehicle.

13. The system of claim 11, wherein the Magneto-Rheological fluid comprises approximately twenty percent iron.

14. The vehicle of claim 11, wherein the fluid damper comprises servo controlled hydrolytic fluid damper.

15. A vehicle, comprising:
an engine;
a header coupled to a body of the vehicle and supporting a roof of the vehicle;
a sensor for providing a signal indicating vibrations in the header; and
a fluid damper mounted to the header, the fluid damper being adjustable responsive to the signal thereby attenuating the vibrations to reduce acoustic noise within the vehicle.

16. The vehicle of claim 15, wherein the sensor comprises an accelerometer for sensing lateral vibrations in the header in a range of 50-90 Hertz.

17. The vehicle of claim 15, wherein the fluid damper comprises a servo controlled hydrolytic fluid damper.

18. The vehicle of claim 15, wherein the fluid damper comprises a Magneto-Rheological fluid damper.

19. The vehicle of claim 15, which includes a control module coupled to the engine and wherein the control module is configured to determine a speed of the vehicle and provide another signal to adjust the fluid damper based upon the speed of the vehicle.

20. The vehicle of claim 15, which includes a control module coupled to the engine and wherein the control module is configured to determine engine revolutions of the engine and provide another signal to adjust the fluid damper based upon the engine revolutions.
